(19) United States
(12) Patent Application Publication
(10) Pub. No.: US 2022/0211031 A1
(43) Pub. Date: Jul. 7, 2022

(54) METHOD AND SYSTEM FOR EX-VIVO HEART PERFUSION

(71) Applicant: University Health Network, Toronto (CA)

(72) Inventors: Mitesh Vallabh BADIWALA, Toronto (CA); Jean W. ZU, Hoboken, NJ (US); Liming XIN, Toronto (CA); Vivek RAO, Toronto (CA); Bryan GELLNER, Toronto (CA); Roberto Vanin Pinto RIBEIRO, Toronto (CA)

(73) Assignee: University Health Network, Toronto (CA)

(21) Appl. No.: 17/706,308

(22) Filed: Mar. 28, 2022

Related U.S. Application Data
(63) Continuation of application No. 16/606,404, filed on Oct. 18, 2019.
(60) Provisional application No. 62/488,123, filed on Apr. 21, 2017.

(51) Int. Cl. A01N 1/02

(52) U.S. Cl. CPC A01N 1/0247

(57) ABSTRACT

Described are methods of performing perfusion on a heart having a left atrium, a right atrium, a pulmonary artery. The methods are performed on a device configured for selectively performing perfusion in at least a Langendorff mode and a right-sided working mode. The methods include performing profusion on a heart in a right-side working mode of the device in which an aortic line is open, a left atrial line is closed, and a reservoir return line is closed.

### CROSS-REFERENCE TO RELATED APPLICATIONS

This application is a continuation of U.S. application Ser. No. 16/606,404, filed Oct. 18, 2019, which is a U.S. national stage application under 35 U.S.C. § 371 of International Application No. PCT/CA2018/000068, filed Apr. 5, 2018, which claims the benefit of U.S. Provisional Patent Application No. 62/488,123, filed Apr. 21, 2017, the entire contents of each priority application of which is incorporated herein by reference.

### FIELD

This relates to preservation and evaluation of isolated hearts, and in particular to performance of perfusion on hearts in multiple modes of operation.

### BACKGROUND

Cardiac transplantation is an important treatment option for many patients with advanced heart failure. Its widespread application however, is limited by a scarcity of usable donor hearts as compared to eligible recipients. Cold static storage, the accepted technique for organ preservation between heart excision and transplantation, does not provide a means for differentiating between grafts with reversible damage and those with irreversible damage. By providing a platform for reanimating and assessing donor heart viability, Ex-Vivo Heart Perfusion (EVHP) systems have been developed to address the paucity of donor organs.

One common mode for EVHP, Langendorff mode, involves re-animating isolated hearts by providing oxygenated perfusate to the aorta in a retrograde direction. While well established, Langendorff Mode perfusion is a non-working mode, precluding the assessment of physiologically relevant contractile function.

Some existing EVHP systems may allow for the functional assessment of the left side of the heart by facilitating a so-called working mode. Right ventricular functional parameters however, which might be important predictors for post-transplant organ outcomes, have remained unexplored. A system capable of facilitating both preservation and biventricular cardiac assessment would be advantageous.

### SUMMARY

According to one aspect of the invention, there is provided a system for performing perfusion on a heart having a left atrium, a right atrium, a pulmonary artery, and an aorta, the system comprising: a reservoir containing fluid; a first pump configured to deliver a first portion of the fluid to a left-side line; a left atrial line connected to the left-side line via a left atrial line clamp, the left atrial line configured to connect to the left atrium; an aortic line connected to the left-side line via an aortic line clamp, the aortic line configured to connect to the aorta of the heart; a reservoir return line connected at a distal end to the reservoir, the reservoir return line further connected at a proximal end to the aortic line via reservoir return clamp; and a pulmonary return line connected at a distal end to the reservoir, the pulmonary return line configured to connect at a proximal end to the pulmonary artery.

In some embodiments, a second pump is connected to the reservoir, the second pump configured to pump a second portion of the fluid to a right-side line, and the right-side line is configured to connect to the right atrium.

In some embodiments, the left atrial line comprises an adjustable resistor.

In some embodiments, the system further comprises a return bypass line connected in parallel with the reservoir return line via a bypass clamp.

In some embodiments, the return bypass line includes a first afterload configured to store and release energy.

In some embodiments, the pulmonary return line comprises a second afterload configured to store and release energy.

In some embodiments, the left-side line comprises a first valve configured to prevent the flow of gas bubbles.

In some embodiments, the reservoir return line includes a second valve configured to prevent the flow of air from the reservoir to the aortic line.

In some embodiments, the system further comprises a sampling port connected to the left-side line via a third valve, the sampling port configured to facilitate extraction of samples of the fluid.

In some embodiments, at least one of the first pump and the second pump is a centrifugal pump.

In some embodiments, the second pump is configured to pump the second portion of the fluid to the right atrium with a specified pressure.

In some embodiments, the aortic line clamp is set to an open position, the left atrial line clamp is set to an open position, and the reservoir return clamp is set to an open position.

In some embodiments, the aortic line clamp is set to an open position, the left atrial line clamp is set to an open position, and the reservoir return clamp is set to an open position.

In some embodiments, the system further comprises a return bypass line connected in parallel with the reservoir return line via a bypass clamp, the aortic line clamp is set to a closed position, the left atrial line clamp is set to an open position, the reservoir return clamp is set to a closed position, and the bypass clamp is set to an open position.

In some embodiments, the aortic line clamp is set to an open position, the left atrial line clamp is set to a closed position, and the reservoir return clamp is set to a closed position.

In some embodiments, the aortic line clamp is set to a closed position, the left atrial line clamp is set to an open position, the reservoir return clamp is set to a closed position, and the bypass clamp is set to an open position.

In some embodiments, the aortic line clamp is set to an open position, the left atrial line clamp is set to a closed position, and the reservoir return clamp is set to a closed position.

According to another aspect, there is provided a method of performing perfusion on a heart having a left atrium, a right atrium, a pulmonary artery, and an aorta, the method comprising: providing a reservoir containing fluid; providing a first pump configured to deliver a first portion of the fluid to a left-side line; providing a left atrial line connected to the left-side line via a left atrial line clamp, wherein the left atrial line is configured to connect to the left atrium; providing an aortic line connected to the left side line via an aortic line clamp, the aortic line configured to connect to the aorta; providing a reservoir return line connected at a proximal end to the aortic line via a reservoir return clamp, the reservoir return line further connected at a distal end to the reservoir; and providing a pulmonary return line connected at a distal end to the reservoir, the pulmonary return line configured to connect at a proximal end to the pulmonary artery.

In some embodiments, the method further comprises: providing a right side line configured to connect to the right atrium; and providing a second pump connected to the reservoir, the second pump configured to pump a second portion of the fluid to the right-side line.

In some embodiments, the aortic line clamp is set to an open position, the left atrial line clamp is set to a closed position, and the reservoir return clamp is set to a closed position, and the method further comprises: delivering the first portion of the fluid to the aorta via the aortic line; circulating the first portion of the fluid through coronary arteries, heart tissues, and coronary veins of the heart; and returning an output fluid from the pulmonary artery to the reservoir via the pulmonary return line.

In some embodiments, the pulmonary return line includes a second afterload configured to store and release energy.

In some embodiments, the aortic line clamp is set to an open position, the left atrial line clamp is set to an open position, and the reservoir return clamp is set to an open position.

In some embodiments, the method further comprises: delivering at least some of the first portion of the fluid to the aorta via the aortic line; and delivering at least some of the first portion of the fluid to the left atrium via the left atrial line.

In some embodiments, the method further comprises: during a first period of time, circulating the at least some of the first portion of the fluid through one or more of coronary arties, heart tissue, and coronary veins of the heart; and during a second period of time, delivering at least some of the first portion of the fluid to the reservoir via the reservoir return line.

In some embodiments, the method further comprises: controlling a pressure at the left atrium by adjusting a variable resistor in the left atrial line.

In some embodiments, the method further comprises providing a right side line configured to connect to the right atrium; and providing a second pump connected to the reservoir, configured to pump a second portion of the fluid to the right atrium.

In some embodiments, the method further comprises: providing a bypass line connected in parallel with the reservoir return line via a bypass clamp, the aortic line clamp is set to a closed position, the left atrial line clamp is set to an open position, the reservoir return clamp is set to a closed position, and the bypass clamp is set to an open position.

In some embodiments, the method further comprises: delivering the first portion of the fluid to the left atrium via the left atrial line; and returning an output fluid from the aorta to the reservoir via the aortic line, the reservoir return line, and the bypass line.

In some embodiments, returning the output fluid from the aorta to the reservoir comprises the output fluid travelling through a first afterload in the bypass line, and the first afterload is configured to store and release energy.

In some embodiments, returning an output fluid from the aorta to the reservoir comprises the output fluid travelling through a valve configured to prevent backflow from the reservoir.

In some embodiments, the method further comprises: providing a right side line configured to connect to the right atrium; and providing a second pump connected to the reservoir, the second pump configured to pump a second portion of the fluid to the right atrium.

In some embodiments, the method further comprises: providing a right side line configured to connect to the right atrium; and providing a second pump connected to the reservoir, the second pump configured to pump a second portion of the fluid to the right atrium.

### BRIEF DESCRIPTION OF DRAWINGS

In the figures, which depict example embodiments:

FIG. 1A is a block diagram of an example system for performing perfusion on a heart;

FIG. 1B is a block diagram of an alternative embodiment of an example system for performing perfusion;

FIG. 2A is a block diagram of the example system of FIG. 1A configured to operate in Langendorff mode;

FIG. 2B is a block diagram of the example system of FIG. 1B configured to operate in Langendorff mode;

FIG. 2C is a simplified block diagram of the example systems of FIGS. 2A and 2B in operation;

FIG. 3A is a block diagram of the example system of FIG. 1A configured to operate in a pump-supported working mode;

FIG. 3B is a simplified block diagram of the example system of FIG. 3A in operation;

FIG. 3C is a block diagram of the example system of FIG. 1B configured to operate in a pump-supported working mode;

FIG. 3D is a simplified block diagram of the example system of FIG. 3C in operation;

FIG. 4A is a block diagram of the example system of FIG. 1A configured to operate in a passive working mode;

FIG. 4B is a simplified block diagram of the example system of FIG. 4A in operation;

FIG. 4C is a block diagram of the example system of FIG. 1B configured to operate in a passive working mode;

FIG. 4D is a simplified block diagram of the example system of FIG. 4C in operation;

FIG. 5A is a block diagram of the example system of FIG. 1A configured to operate in a right-sided working mode;

FIG. 5B is a block diagram of the example system of FIG. 1B configured to operate in a right-sided working mode;

FIG. 5C is a simplified block diagram of the example systems of FIGS. 5A and 5B in operation;

FIG. 6 is a flow chart for an example method of performing a perfusion on a heart, according to some embodiments.

### DETAILED DESCRIPTION

Some strategies for ex vivo perfusion focus on different Working Modes enabling graft evaluation during perfusion. According to a first strategy, a two-chamber Working Mode can be employed in which blood is provided only to the left atrium and ejected from the left ventricle to perfuse the coronaries. According to another strategy, a four-chamber working heart platform using a pump to load the left atrium and a reservoir to load the right atrium by gravity can be employed. Decoupled designs of the loading system, however, may make it difficult to individually manipulate the preload of the left and right sides. Additionally, such systems may rely on the use of reservoir height to control right atrial pressure, which can limit the system's ability to facilitate precise control of atrial loading throughout the perfusion period.

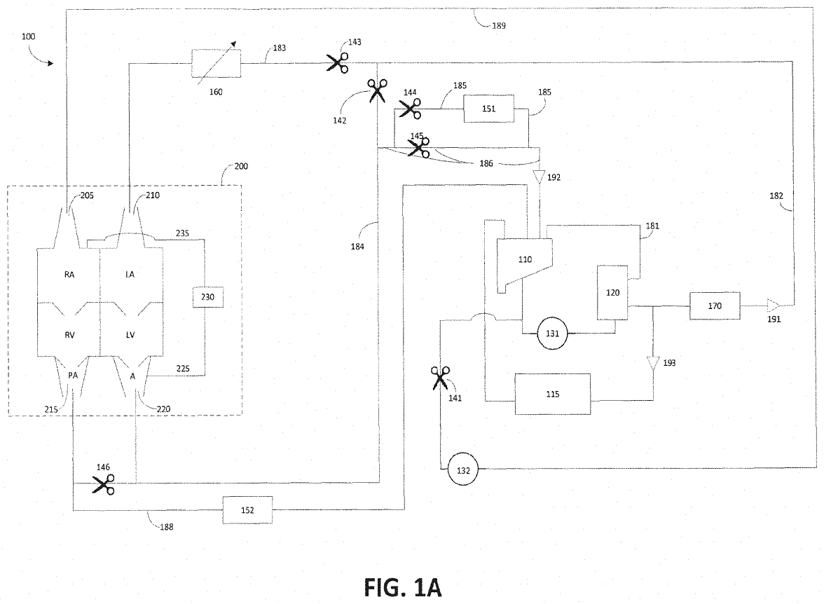

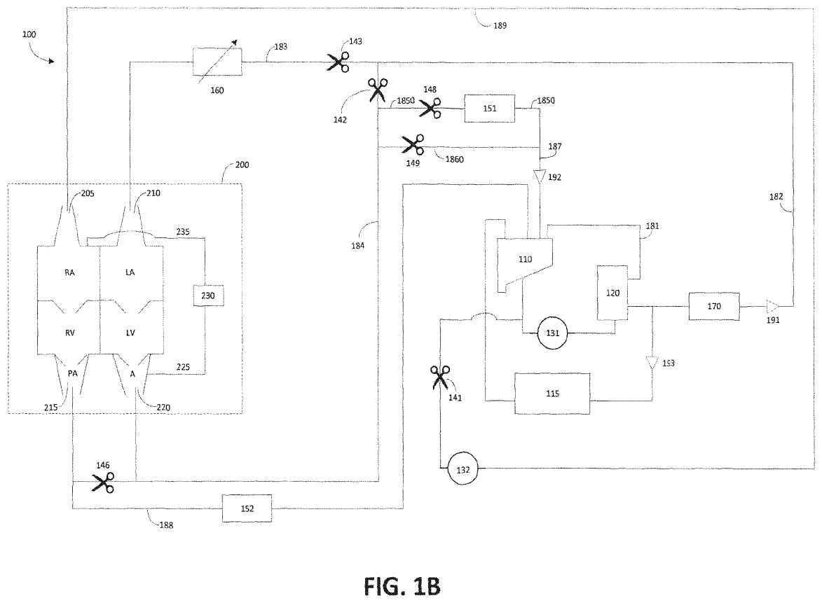

FIG. 1A is a block diagram of an example system 100 for performing a perfusion on a heart 200. In some embodiments, the heart 200 is an animal heart. In some embodiments, the heart 200 is a human heart. As depicted, heart 200 further includes coronary arteries 225, heart tissue 230, and coronary veins 235. In FIG. 1A, RA denotes the right atrium, LA denotes the left atrium, RV denotes the right ventricle, LV denotes the left ventricle, PA denotes the pulmonary artery, and A denotes the aorta of heart 200.

As depicted, example system 100 comprises a reservoir 110, an oxygenator 120, a first pump 131, a second pump 132, a reservoir clamp 141, an aortic line clamp 142, a left atrial line clamp 143, a bypass clamp 144, a reservoir return clamp 145, a priming clamp 146, afterloads 151, 152, variable resistor 160, filter 170, sampling port 115, and a plurality of valves 191-193. System 100 further comprises a plurality of lines 181-189 operable to transport fluids. The system 100 is operable to connect to one or more locations 205, 210, 215, 220 on heart 200. As depicted, clamps 141-146 are illustrated using a clamp symbol. Throughout the specification and drawings, when the clamps are illustrated as being parallel to a line, this signifies that the clamp is in an open position. When the clamps are illustrated as being perpendicular to a line, this signifies that the clamp is in position. In FIG. 1A, each of clamps 141-146 are illustrated in the “open” position.

It should be appreciated that the example embodiment of system 100 depicted in FIG. 1A is an example and that various embodiments need not include every single element depicted in FIG. 1A. Further example configurations of system 100 may include some or all of the components outlined above in relation to FIG. 1A.

Reservoir 110 is used as a container for fluids. Fluids used for perfusion are referred to herein after as perfusate. Perfusate may include, for example, blood, and/or other movable materials used for perfusion. In some embodiments, the perfusate in reservoir 110 is de-oxygenated. Reservoir 110 is connected to first pump 131. In some embodiments, first pump 131 is located at a lower vertical height than reservoir 110, thereby allowing gravity to assist with the flow of perfusate from reservoir 110 to first pump 131. In some embodiments, the first pump 131 can apply a suction pressure to reservoir 110 to assist with drawing perfusate out from reservoir 110. In some embodiments, the first pump 131 is a centrifugal pump.

In some embodiments, a second pump 132 is connected downstream from reservoir 110, via reservoir clamp 141. Reservoir clamp 141 can be switched between an open state (allowing perfusate to flow to second pump 132) and a closed state (preventing the flow of perfusate from reservoir 110 to second pump 132). In some embodiments, one or both of first and second pumps 131, 132 are centrifugal pumps. In some embodiments, the output of second pump 132 is connected via right-side line 189 to connection point 205 of heart 200. In some embodiments, connection point 205 of heart 200 corresponds to the right atrium of heart 200.

As depicted, perfusate flows from first pump 131 to oxygenator 120. In some embodiments, oxygenator 120 further comprises a heat exchanger. In some embodiments, an output of oxygenator 120 is connected to reservoir 110 by way of purge line 181. Purge line 181 is operable to allow gas to vent from oxygenator 120 and back into reservoir 110.

In some embodiments, an output line from oxygenator 120 is further connected to a filter 170. Filter 170 may be used to filter various materials from the fluid. Filter 170 may be an arterial filter, which may be used to filter white blood cells (e.g. leukocytes) from the perfusate. Filter 170 may also serve as a de-airing device or bubble trap. In some embodiments, a one-way valve 191 is connected downstream from filter 170. Valve 191 may be useful in preventing the flow of any air bubbles into left-side line 182. In some embodiments, the perfusate flowing through line 182 may ultimately flow to one or more portions on the left side of heart 200. The introduction of air bubbles to heart 200 may cause an air embolism in the coronary arteries 225, which may cause fibrillation. This may cause damage to heart 200 or even loss of heart 200. Thus, it is desirable to prevent the flow of air bubbles in left-side line 182 through the use of valve 191.

From valve 191, left-side line 182 proceeds until separating into left atrial line 183 and aortic line 184. In some embodiments, left-side line 182 and left atrial line 183 are separated by left atrial line clamp 143. In some embodiments, left-side line 182 and aortic line 184 are separated by aortic line clamp 142. In some embodiments, left atrial line 183 is connected to variable resistor 160. After variable resistor 160, left atrial line 183 is then operable to be connected to connection 210 of heart 200. In some embodiments, connection 210 corresponds to the left atrium of heart 200.

In some embodiments, aortic line 184 is connected to connection 220 of heart 200. In some embodiments, connection 220 corresponds to the aorta of heart 200. In some embodiments, aortic line 184 is further connected to pulmonary return line 188 via priming clamp 146. Priming clamp 146 can be switched from an open state (connecting aortic line 184 to pulmonary return line 188) and a closed state (disconnecting aortic line 184 and pulmonary return line 188). Pulmonary return line 188 is connected to a connection 215 of heart 200. In some embodiments, connection 215 corresponds to the pulmonary artery of heart 200.

As depicted in FIG. 1A, pulmonary return line 188 is further connected to and drains into reservoir 110 via reservoir return line 186. In some embodiments, a bypass line 185 is connected in parallel with reservoir return line 186 via bypass clamp 144. In some embodiments, bypass line 185 includes an afterload 151 configured to store and release energy. In some embodiments, reservoir return line 186 includes a one-way valve 192. One-way valve is operable to prevent backflow of air bubbles from reservoir 110 into reservoir return line 186. This may prevent air bubbles from reservoir 110 from reaching heart 200 and potentially causing damage. It should be noted that although FIG. 1A includes both reservoir return line 186 and bypass line 185, in some embodiments, bypass line 185 may be omitted.

In some embodiments, reservoir return line 186 connects to aortic line 184. In some embodiments, reservoir return clamp 145 enables flow from aortic line 184 to reservoir 110. Reservoir return clamp 145 may be changed from an open state (in which perfusate flows from aortic line 184 to reservoir 110, optionally via one-way valve 192). Bypass clamp 144 may be changed from an open state (in which perfusate flows via bypass line 185 via afterload 151 to reservoir return line 186 and ultimately to reservoir 110, optionally via one-way valve 192). In some embodiments, clamps 144 and 145 are not in an open state simultaneously during operation. In some embodiments, both of clamps 144 and 145 may be closed. Optionally, an additional clamp (not shown) can be included between aortic line 184 and the point at which bypass line 185 branches from reservoir return line 186, which may minimize the amount of perfusate that exits aortic line 184 when both of clamps 144 and 145 are closed.

An alternative embodiment for system 100 is shown in FIG. 1B. As depicted in FIG. 1B, pulmonary return line 188 is further connected to and drains into reservoir 110 via first return line 1850 or second return line 1860. In some embodiments, first return line 1850 includes afterload 152. In some embodiments, first return line 1850 and second return line 1860 join at a junction to form reservoir return line 187. In some embodiments, reservoir return line 187 includes one-way valve 192. During low flow conditions, there may be a tendency for air from reservoir 110 to flow to heart 200. As noted above, it is preferable not to allow air bubbles to travel to heart 200. One-way valve 192 prevents backflow of air from reservoir 110 and thus reduces the likelihood of air from reservoir 110 travelling to heart 200. It should be noted that although FIG. 1B includes both first return line 1850 and second return line 1860, in some embodiments one of lines 1850 and 1860 is sufficient. In some embodiments, neither of lines 1850 and 1860 is present.

In some embodiments (e.g. FIG. 1B), first return line 1850 connects aortic line 184 to an afterload 151 via first return clamp 148. First return clamp 148 can be switched between an open state (connecting first return line 1850 to afterload 151) and a closed state (preventing first return line 1850 from being in fluid communication with afterload 151). Afterload 151 then connects via first return line 1850 to reservoir return line 187, which connects to reservoir 110. In some embodiments, a one-way valve 192 separates reservoir return line 187 and reservoir 110.

In some embodiments (e.g. FIG. 1B), second return line 1860 connects to reservoir return line 187. Reservoir return line 187 then connects to reservoir 110. In some embodiments, second return line 1860 connects to reservoir return line 187 via second return clamp 149. Second return clamp 149 can be switched between an open state (connecting second return line 1860 to reservoir return line 187) and a closed state (preventing second return line 1860 from being in fluid communication with reservoir return line 187).

Some embodiments include afterloads 151, 152. Afterloads 151, 152 are elements which are operable to store energy (e.g. in the form of elastic potential energy) and subsequently release that stored energy. The stored energy may be exerted in the opposite direction in certain situations. An afterload element may include, for example, a balloon, a Windkessel, a membrane partially filled with gas, a spring-loaded piston, or a compliant membrane operable to store energy. In some embodiments, an afterload element simulates the behaviour of blood vessels (which are known to expand in high pressure conditions and return to their resting size (or contract passively) when pressure is reduced).

As perfusate flows into an afterload element 151, 152, energy is gradually stored (e.g. as a balloon fills, energy is stored in the form of elastic potential energy as the balloon stretches). Likewise, fluid can exert a pressure against a spring-loaded piston, causing the spring to store elastic potential energy. Afterload elements 151, 152 may be useful in simulating the pressure caused by the circulatory system external to heart 200. For example, during regular functioning operation of a circulatory system, blood vessels may stretch when subjected to increased pressure (e.g. during systole, when heart muscles contract and blood is forced into blood vessels). When that increased pressure subsides (e.g. during diastole, when heart muscles relax and chambers fill with blood), the blood vessels may then return to their resting size (or contract passively).

Oxygenator 120 exposes fluids to oxygen. For example, oxygenator 120 may accept deoxygenated perfusate as an input, and output oxygenated perfusate. In some embodiments, an output of oxygenator 120 may be further connected to sampling port 115 via a one-way valve 193. Sampling port 115 is then connected to reservoir 110. Sampling port 115 may be used to extract samples of blood or perfusate for analysis. Samples may be taken to analyze, for example, levels of pH, lactate, hemoglobin, hematocrit, oxygen saturation, electrolytes, lactate, blood gases, other metabolites (e.g. liver enzymes, creatinine, urea, glucose), as well as the partial pressure of oxygen, and the like. Sampled perfusate can also be stored and used for assays at later times (e.g. for the quantification of endothelin-1, troponin 1, oxidative stress markers, or the like).

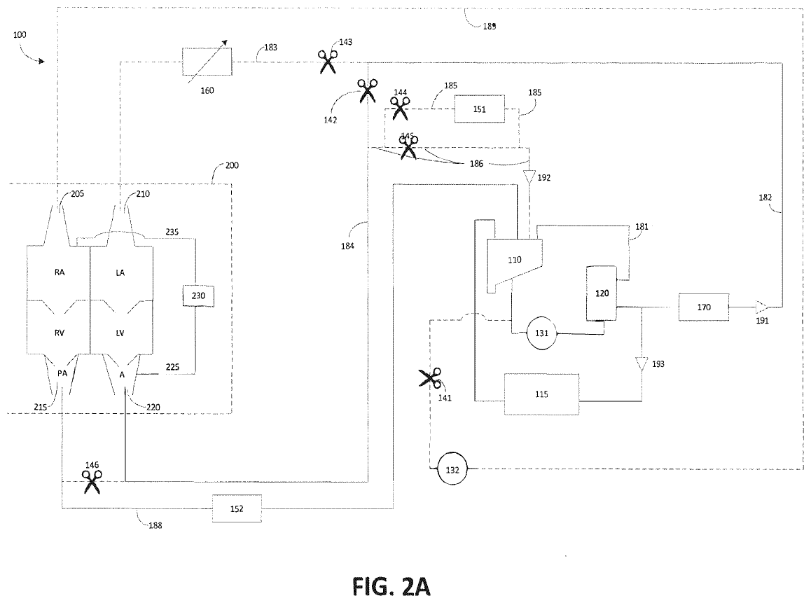

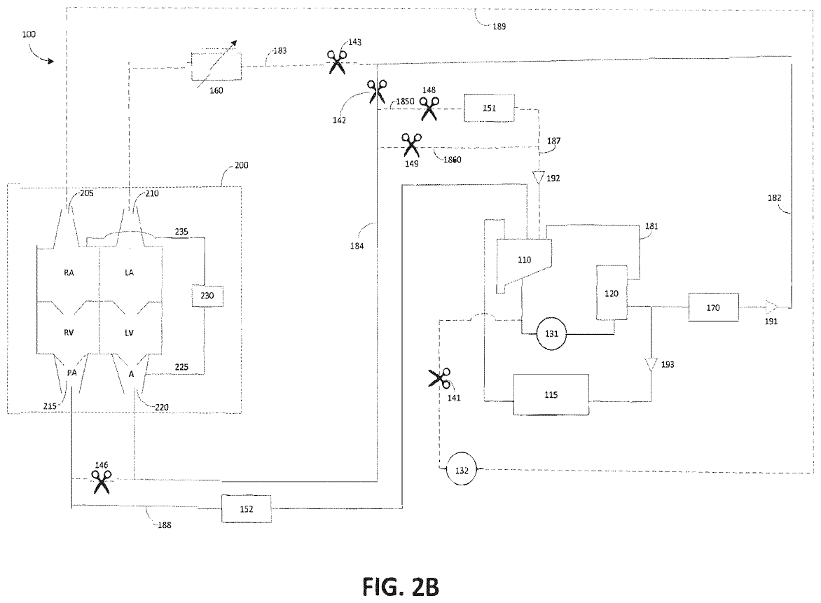

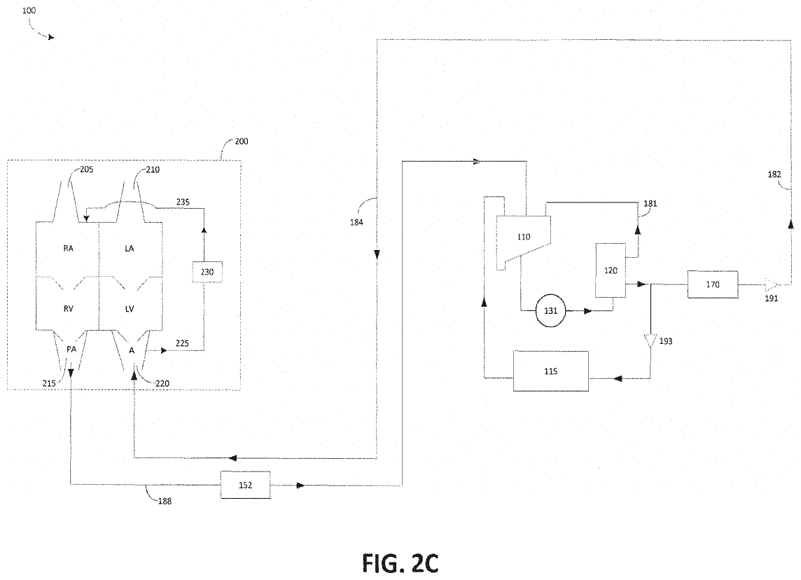

In some embodiments, system 100 is operable to switch between a plurality of different operating modes. FIG. 2A is a block diagram of the example system of FIG. 1A configured to operate in Langendorff mode. FIG. 2B is a block diagram of the example system of FIG. 1B configured to operate in Langendorff mode. Langendorff mode may be used to reanimate and/or resuscitate a candidate heart from a state of cardiac arrest, asystole or cold storage, to defibrillate a heart undergoing fibrillation, and may also be used to test the performance of various mechanical and electrophysiological parameters associated with a candidate heart 200.

As depicted in FIGS. 2A and 2B, reservoir clamp 141 is in a closed position (denoted by clamp 141 being perpendicular to the line leading to second pump 132), and the second pump 132 is turned off. Hereinafter, the illustration of a clamp being perpendicular to a line in the figures denotes that the clamp is closed. Thus, no perfusate is sent to input 205 of heart 200 via line 189. Left atrial clamp 143 is in a closed position, and perfusate carried in left-side line 182 does not flow to left atrial line 183 or to variable resistor 160. Aortic line clamp 142 is in an open position, which allows perfusate to pass from left-side line 182 to aortic line 184 and to input 220 of heart 200.

In FIG. 2A, bypass clamp 144 and reservoir return clamp 145 are both closed, thereby preventing any flow from aortic line 184 to reservoir 110. In FIG. 2B, first return clamp 148 and second return clamp 149 are in closed positions, thereby preventing fluid flow through any of lines 1850, 1860 and 187, as well as afterload 151. Priming clamp 146 is in a closed position, and therefore aortic line 184 and pulmonary return line 188 are not in fluid communication.

FIG. 2B is a simplified block diagram of the example system of FIGS. 2A and 2B in operation, in which lines which are not operable to carry fluids are not shown. In operation, perfusate from reservoir 110 flows to the first pump 131. In some embodiments, the first pump 131 is located at a lower height than reservoir 110, and fluid flow to pump 131 is aided by gravity. In some embodiments, the first pump 131 is a centrifugal pump. In some embodiments, first pump 131 is set to approximately 1500 rpm, although any suitable speed can be chosen. Perfusate then flows from first pump 131 to oxygenator 120, which exposes the perfusate to oxygen. In some embodiments, oxygenator 120 further comprises a heat exchanger. Excess gas may be returned to reservoir 110 via purge line 181. In some embodiments, some of the oxygenated perfusate output from oxygenator 120 passes through one-way valve 193 and to sampling port 115, and then back to reservoir 110. In some embodiments, the above-described line with one-way valve 193 and sampling port 115 is not present.

Oxygenated perfusate flows from the oxygenator 120 to filter 170, and then through one-way valve 191. In some embodiments, one-way valve 191 is operable to prevent gas bubbles from flowing through left-side line 182. Gas bubbles may cause damage to heart 200 if allowed to travel to heart 200, as noted above.

The oxygenated, filtered perfusate then flows (under pressure from first pump 131) through left-side line 182 and through to aortic line 184. The oxygenated, filtered perfusate ultimately flows to connection 220 of heart 200. In some embodiments, the connection 220 corresponds to the aorta of heart 200. Because the aortic valve is a one-way valve, entry into the left ventricle of heart 200 is prevented, and the perfusate is diverted.

The oxygenated, filtered perfusate applies a pressure to the aortic valve of heart 200. In some embodiments, the pressure is approximately 50 mmHg at the aortic valve. This pressure may cause the aortic valve to close, and since the perfusate cannot enter the left ventricle, the perfusate is instead forced to pass through the coronary arteries 225. As the perfusate passes through various heart tissues (e.g. muscle and other cells—depicted as heart tissue 230), oxygen in the perfusate is consumed. The deoxygenated perfusate then flows through coronary veins 235 and empties into the right atrium of heart 200. The deoxygenated perfusate then flows from the right atrium to the right ventricle, and flows out of the pulmonary artery at connection 215 and into pulmonary return line 188. The deoxygenated perfusate is then passed through afterload 152 and ultimately to reservoir 110.

As will be appreciated, the pressure generated by first pump 131 is sufficient to cause the perfusate to flow through oxygenator 120, filter 170, valve 191, left-side line 182, aortic line 184, coronary arteries 225, heart tissue 230 and coronary veins 235. In some embodiments, once the perfusate enters the right atrium, the pumping mechanism of heart 200 causes the perfusate to move to the right ventricle, and ultimately out to the pulmonary artery and into pulmonary return line 188. In some embodiments, it is desirable to prevent a condition in which there is negative pressure in the pulmonary artery. As noted above, the afterload 152 is operable to store elastic potential energy as fluid flows through afterload 152, and during moments of reduced pressure (e.g. diastole), the afterload 152 applies a reverse pressure, which may prevent a condition of negative pressure in the pulmonary artery.

The Langendorff mode may be useful for measuring certain properties of a candidate heart 200, including, but not limited to myocardial oxygen consumption, lactate extraction, metabolite production, or the like. The perfusate can be sampled at sampling port 115 and analyzed for any number of parameters described herein. Generally, the Langendorff mode will be the first mode that a candidate heart will be subjected to during ex-vivo (i.e. outside of the body) testing.

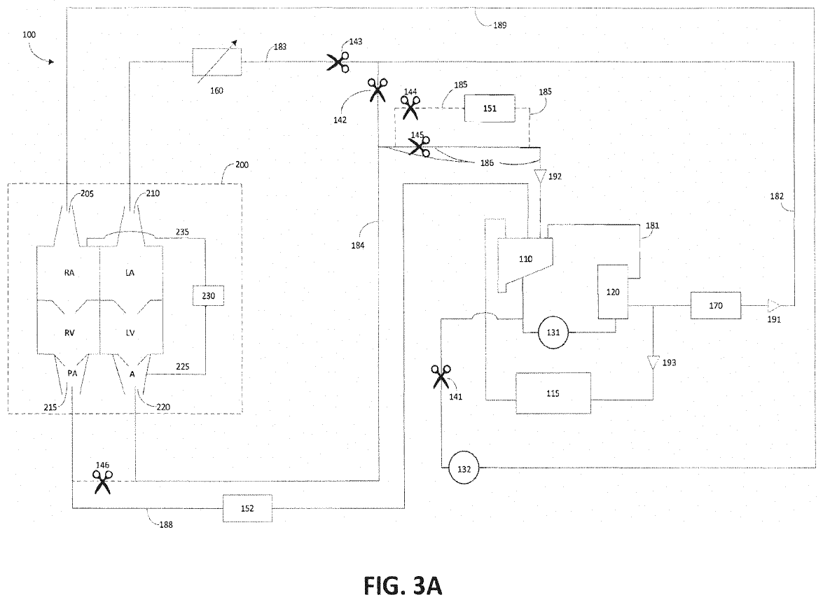

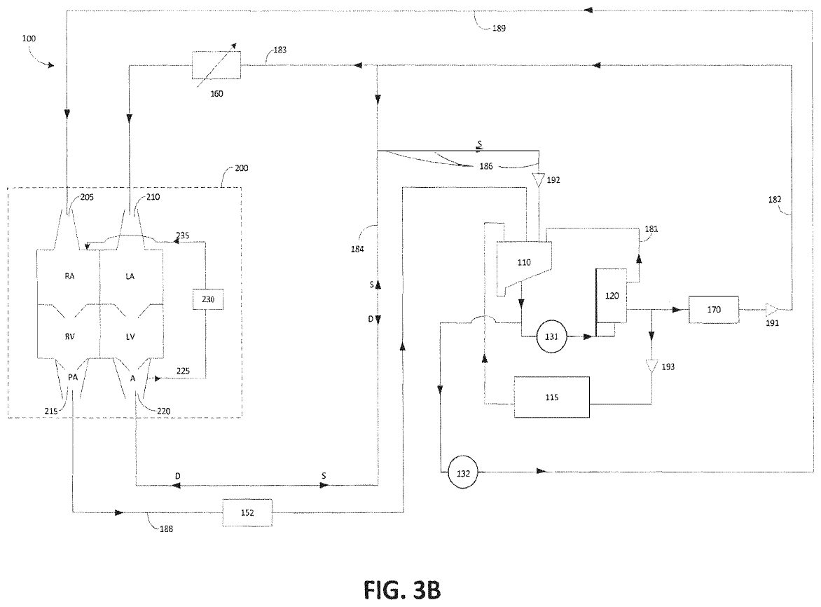

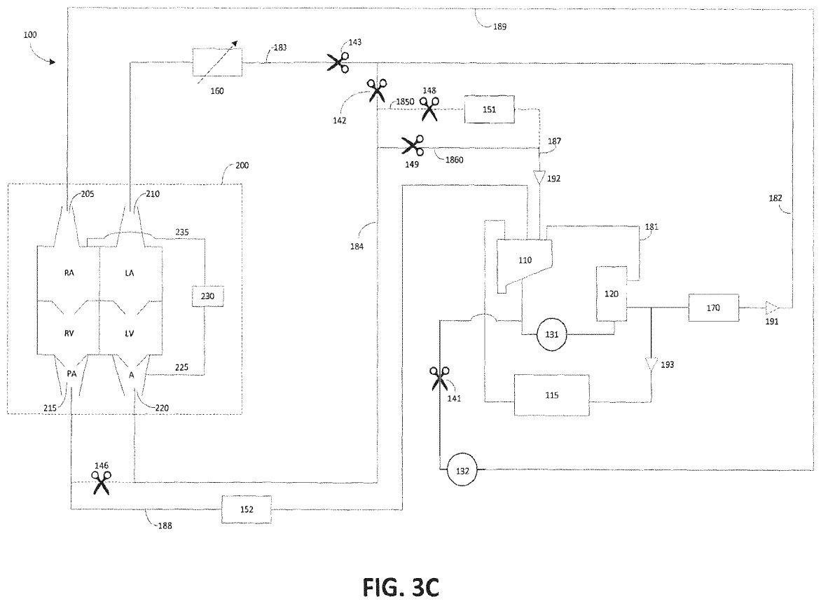

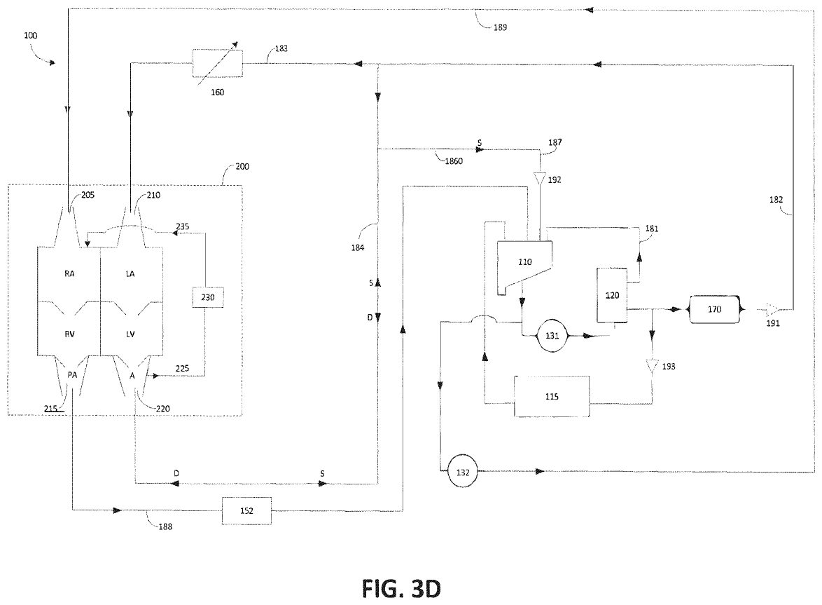

In some embodiments, system 100 is further operable to operate in a pump-supported working mode. FIG. 3A is a block diagram of the example system of FIG. 1A configured to operate in a pump-supported working mode. FIG. 3C is a block diagram of the example system of FIG. 1B configured to operate in a pump-supported working mode.

As depicted in FIG. 3A, in pump-supported working mode, aortic line clamp 142 is open, left atrial clamp 143 is open, bypass clamp 144 is closed, reservoir return clamp 145 is open, and priming clamp 146 is closed. As depicted in FIG. 3C, in pump-supported working mode, aortic line clamp 142 is open, left atrial clamp 143 is open, first return clamp 148 is closed, second return clamp 149 is open, and priming clamp 146 is closed. Optionally, reservoir clamp 141 may be set to an open state and second pump 132 may be activated. FIGS. 3A, 3B, 3C and 3D depict example embodiments in which the reservoir clamp 141 is open, although embodiments are contemplated in which reservoir clamp 141 is closed while in pump supported working mode. FIGS. 3B and 3D are simplified block diagrams of the example systems of FIGS. 3A and 3C in operation, respectively, in which the reservoir clamp 141 is open and second pump 132 is activated.

During operation in pump-supported working mode, perfusate flows from reservoir 110 to first pump 131. The perfusate is then pumped to oxygenator 120, filter 170, and valve 191 to left-side line 182. The perfusate then flows from left-side line 182 to both left atrial line 183 and aortic line 184. A first portion of perfusate flows into left atrial line 183, and a second portion of perfusate flows into aortic line 184. The first portion of fluid in left atrial line 183 flows to connection 210 of heart 200 via variable resistor 160. In some embodiments, connection 210 corresponds to the left atrium of heart 200. The second portion of fluid in aortic line 184 flows into connection 220 of heart 200. In some embodiments, connection 220 corresponds to the aorta of heart 200.

The relative flow of fluid between left atrial line 183 and aortic line 184 may be controlled by adjusting the resistance of variable resistor 160. In some embodiments, variable resistor 160 can be any of an adjustable tubing clamp, a cluster of small tubes (which increase the friction experienced by the perfusate over a similar cross-sectional area), or a system of bends in the tubing. In some embodiments, the variable resistor 160 is adjusted such that the left atrial pressure is between approximately 5 to 10 mmHg. The diastolic pressure (i.e. the pressure in the aorta during diastole) may be maintained around 30 mmHg in pump-supported working mode. In some embodiments, the first pump 131 is a centrifugal pump. In some embodiments, the first pump has a rotational speed of approximately 2000 rpm in pump-supported working mode. It will be appreciated by a person skilled in the art that the rotational speed of the first pump 131 can be adjusted in order to achieve a desired operating condition.

During diastole (denoted by the arrows with the letter D in FIGS. 3B and 3D), the perfusate flowing through aortic line 184 flows to connection 220 of heart 200 (which may correspond to the aorta). The aortic valve of heart 200 will not allow fluid to flow into the left ventricle, and so the perfusate flows through coronary arteries 225, heart tissue 230, and coronary veins 235, and then into the right atrium of heart 200. The perfusate then flows out of the right ventricle via the pulmonary artery, and then through pulmonary return line 188, afterload 152, and into reservoir 110.

During systole (denoted by the arrows with the letter S in FIGS. 3B and 3D), the perfusate that entered the left ventricle during diastole is pumped out the aorta 220. During systole, although the first pump 131 is providing a backpressure against the aorta via aortic line 184, the pressure exerted by the heart 200 during systole is sufficient to overcome that backpressure, and perfusate is caused to flow out of the aorta and into aortic line 184, which then flows through one-way valve 192 into reservoir 110. As depicted in FIG. 3B, the perfusate flows from the aorta 220 to aortic line 184, and then through reservoir return line 186 to valve 192. As depicted in FIG. 3D, the perfusate flows from the aorta 220 to aortic line 184, and then through second return line 1860, to reservoir return line 187, and then to valve 192.

It should be noted that in some embodiments, during systole, some of the perfusate in aortic line 184 being pumped by first pump 131 is still travelling in the direction of heart 200. Thus, although the fluid expelled by the heart 200 during systole travels in a reverse direction to the fluid being pumped by first pump 131, some of that pumped fluid nevertheless is able to reach the aorta, and thus a flow of fluid to the coronary arteries 225, heart tissue 230, and coronary veins 235 is maintained throughout the pump-supported working mode.

It should be appreciated that in some embodiments, during diastole, a low volume or possibly no perfusate is likely to flow into reservoir return line 186 (in the case of FIG. 3B) or second return line 1860 (in the case of FIG. 3D). In some embodiments, the perfusate continues following aortic line 184 downward. However, during systole, the fluid being pumped out of heart 200 via the aorta causes perfusate to build up in aortic line 184, which results in the expelled fluid flowing out of the aorta with sufficient pressure to travel up aortic line 184 in the ‘S’ direction, and ultimately into reservoir return line 186 (in FIG. 3B) or second return line 1860 (in FIG. 3D) and then into reservoir 110.

In some embodiments, in pump-supported working mode, reservoir clamp 141 is in an open position, allowing perfusate to be pumped by second pump 132. Perfusate then flows via right-side line 189 to connection 205 of heart 200. In some embodiments, connection 205 corresponds to the right atrium of heart 200. In some embodiments, second pump 132 is a centrifugal pump. In some embodiments, second pump 132 has a rotation speed of approximately 500 rpm. It will be appreciated that the rotational speed of second pump 132 can be adjusted to achieve target conditions. In some embodiments, the right atrium is loaded with a pressure of approximately 5 to 10 mmHg. The portion of perfusate pumped by second pump 132 is then pumped back to reservoir 110 via pulmonary return line 188 and afterload 152.

As depicted in FIGS. 3A, 3B, 3C and 3D, pump-supported working mode includes reservoir clamp 141 being set to an open state, and second pump 132 being activated. It should be noted that in some embodiments, in pump-supported working mode, reservoir clamp 141 is closed and second pump 132 is not operational.

The pump-supported working mode may provide the ability to evaluate contractile function of heart 200 with a reduced risk of the aortic pressure falling to an unacceptable level (in the event that there is poor contraction) because the first pump 132 assists with the maintenance of diastolic pressure so that the coronary arteries 225 remain perfused. The pump-supported working mode may provide conditions which are closer to simulating physiological conditions compared to Langendorff mode because the heart 200 is loaded.

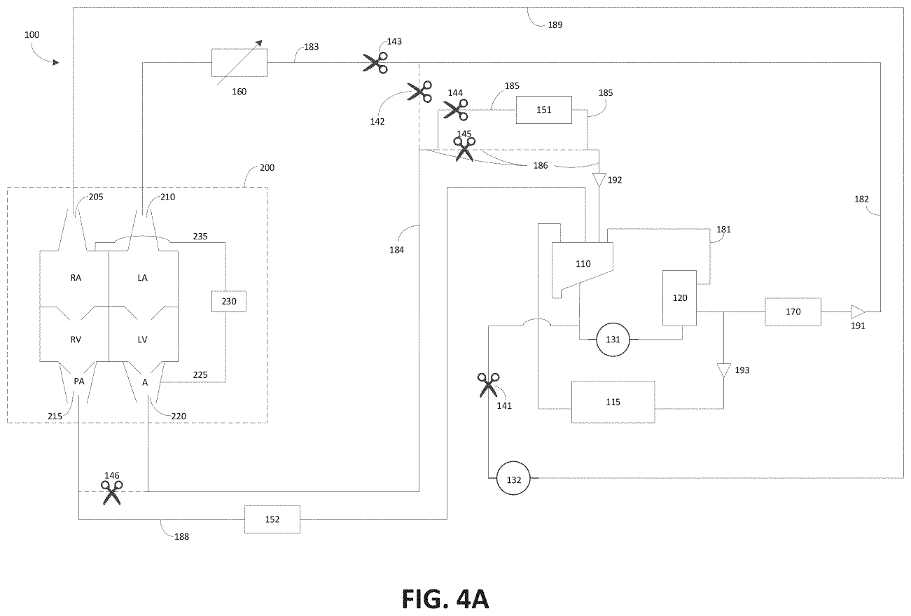

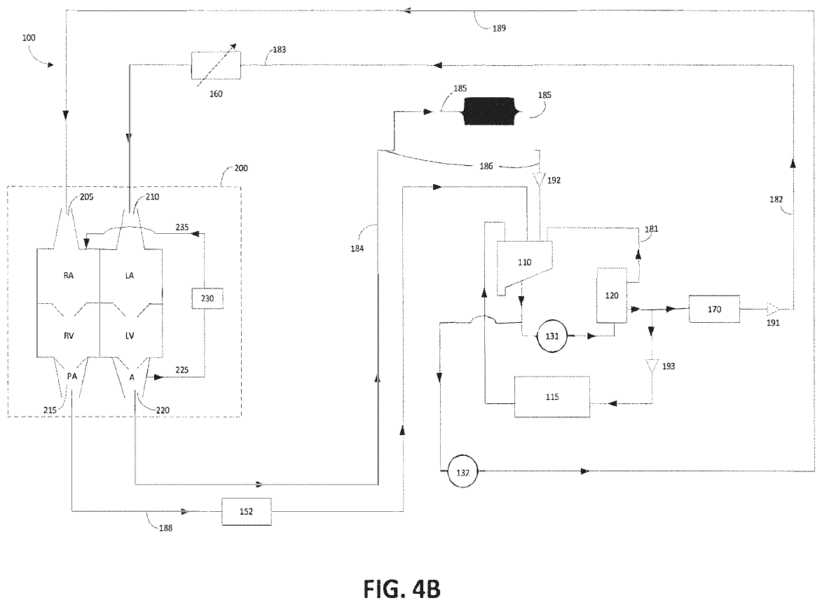

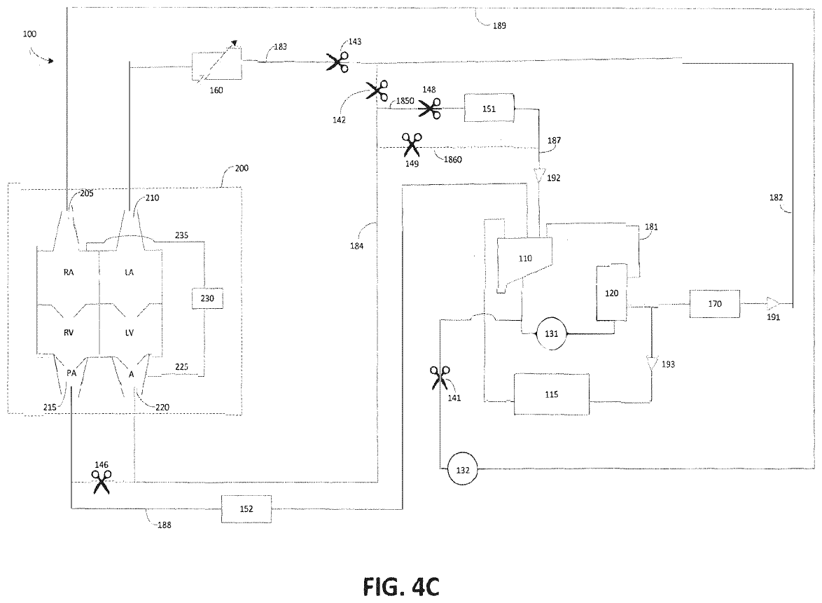

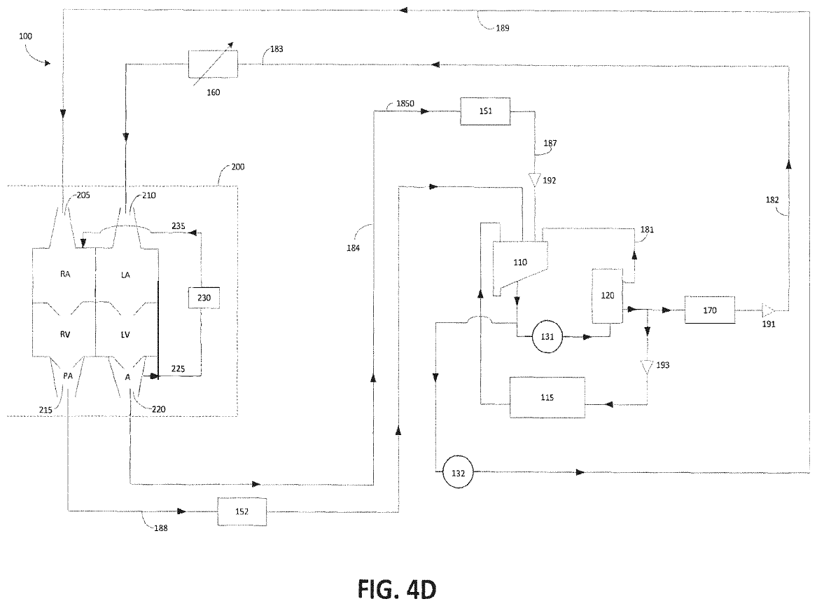

In some embodiments, system 100 is further operable to switch to a passive working mode. FIG. 4A is a block diagram of the example system 100 of FIG. 1A configured to operate in a passive working mode. FIG. 4C is a block diagram of the example system 100 of FIG. 1B configured to operate in a passive working mode.

In FIGS. 4A and 4C, in passive working mode, aortic line clamp 142 is closed, thereby preventing fluid communication between left-side line 182 and aortic line 184. Left atrial clamp 143 is open, thereby allowing fluid to flow from left-side line 182 to left atrial line 183. Priming clamp 146 is closed. In FIG. 4A, reservoir return clamp 145 is closed and bypass clamp 144 is open, thereby causing perfusate to flow from aortic line 184 to reservoir return line 186, then bypass line 185, and then reservoir return line 186 into valve 192 and reservoir 110. In FIG. 4C, second return clamp 149 is closed, thereby preventing fluid from flowing through second return line 1860. First return clamp 148 is open, thereby allowing fluid to flow from aortic line 184 into first return line 1850 and afterload 151.

FIGS. 4B and 4D are simplified block diagrams of the example systems of FIGS. 4A and 4C in operation, respectively, in which lines which do not carry fluids are not shown. As depicted, perfusate is drawn from reservoir 110 by first pump 131. The perfusate is pumped through oxygenator 120 and filter 170, and proceeds via one-way valve 191 to left-side line 182. The perfusate in left-side line 182 flows entirely into left atrial line 183. The fluid in left atrial line 183 then encounters variable resistor 160, which may be used to control the left atrial pressure. In some embodiments, the left atrial pressure is approximately 5 to 10 mmHg. In some embodiments, the first pump 131 is a centrifugal pump. In some embodiments, the first pump 131 has a rotational speed of approximately 700 rpm. It will be appreciated that the rotational speed of first pump 131 in passive working mode can be adjusted to achieve a desired pressure.

The perfusate flows to connection 210 after variable resistor 160. In some embodiments, connection 210 corresponds to the left atrium of heart 200. The left atrium fills with perfusate, which is pumped by heart 200 to the left ventricle. The perfusate in the left ventricle is then pumped out via the aorta and into aortic line 184. Unlike the Langendorff and pump-supported working modes, in passive working mode, no portion of the perfusate pumped by the first pump 131 is pumped through aortic line 184 to apply a pressure at the aortic valve of heart 200.

During systole, the pressure is elevated, and some of the perfusate pumped out of the left ventricle of heart 200 takes a lower resistance path via the coronary arteries 225, heart tissue 230, and coronary veins 235. As depicted in FIG. 4B, during systole, most of the perfusate pumped from the left ventricle into aortic line 184 also flows to afterload 151 via reservoir return line 186 and bypass line 185. As depicted in FIG. 4D, during systole, most of the perfusate pumped from the left ventricle into aortic line 184 also flows to afterload 151 via first return line 1850. Afterload 151 is operable to store energy in the form of elastic potential (for example, during systole). Thus, as the fluid is pumped from aortic line 184 to afterload 151 and ultimately to reservoir 110, the afterload 151 stores potential energy.

During diastole, the pressure in aortic line 184 falls. Thus, the pressure in bypass line 185 (in the case of FIG. 4B) and first return line 185 (in the case of FIG. 4D) falls, and afterload 151 is operable to exert a pressure in aortic line 184 in the reverse direction, which applies a sufficient pressure at the aorta to cause the aortic valve to shut. Moreover, some of the perfusate in aortic line 184 is subjected to the pressure from afterload 151 toward the aorta. This pressure then causes some of the perfusate to flow through coronary arteries 225, heart tissue 230, and coronary veins 235. In some embodiments, the negative pressure from afterload 151 during diastole may ensure that sufficient perfusate is circulated through heart tissues 230 so as to avoid or reduce the likelihood of damaging heart 200. Thus, the heart tissues 230 may receive a sufficient amount of oxygenated perfusate throughout passive working mode for the heart 200 to function.

Optionally, in passive working mode, reservoir clamp 141 may be open, thereby allowing second pump 132 to pump some of the perfusate from reservoir 110. Second pump 132 may then pump perfusate through right-side line 189 to a connection 205 of heart 200. In some embodiments, connection 205 corresponds to the right atrium of heart 200. In some embodiments, second pump 132 is a centrifugal pump. In some embodiments, second pump 132 operates at approximately 500 rpm, although a person skilled in the art will appreciate that the rotational speed can be adjusted to achieve a desired condition. In some embodiments, the second pump 132 is operable to load the right atrium of heart 200 with fluid at a pressure between approximately 5 and 10 mmHg. The fluid in the right atrium (i.e. the perfusate after having passed through heart tissue 230) is ultimately pumped from the right atrium to the right ventricle, which in turn is pumped out into pulmonary return line 188. The fluids expelled into pulmonary return line 188 then pass via afterload 152, and then into reservoir 110.

Passive working mode may provide similar benefits to those outlined above with respect to pump-supported working mode. Passive working mode may offer additional potential benefits in that passive working mode may allow a more physiological perfusion of heart 200 because the systolic and diastolic pressures in the aorta can be controlled independently (i.e. to more closely match in vivo conditions, in some embodiments). Thus, in passive working mode, specific pressures can be applied to simulate heart performance for a particular patient. In pump-supported working mode, it may not be possible to control systolic and diastolic pressures in the aorta independently. In some embodiments, operating in passive working mode may also potentially result in one or more of reduced coronary and heart tissue damage, less edema, and better preservation, long-term viability and contractile function in heart 200.

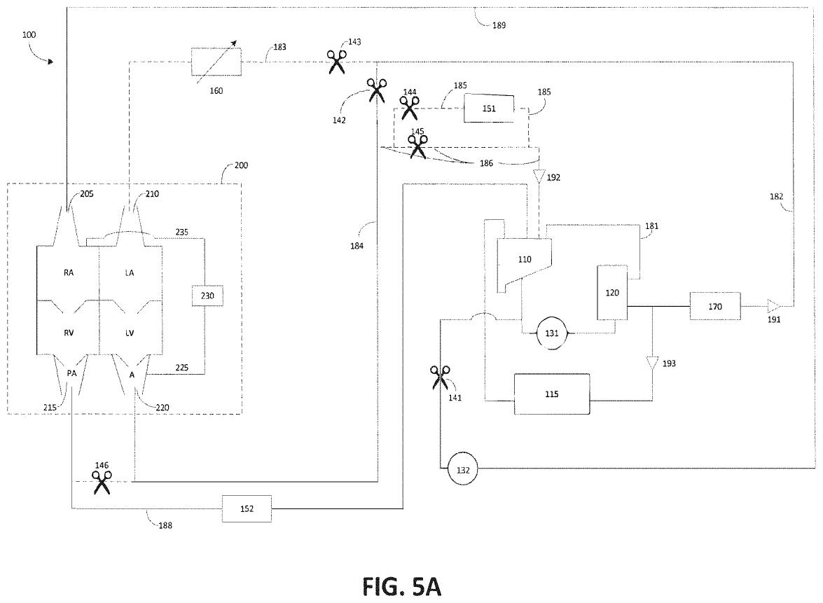

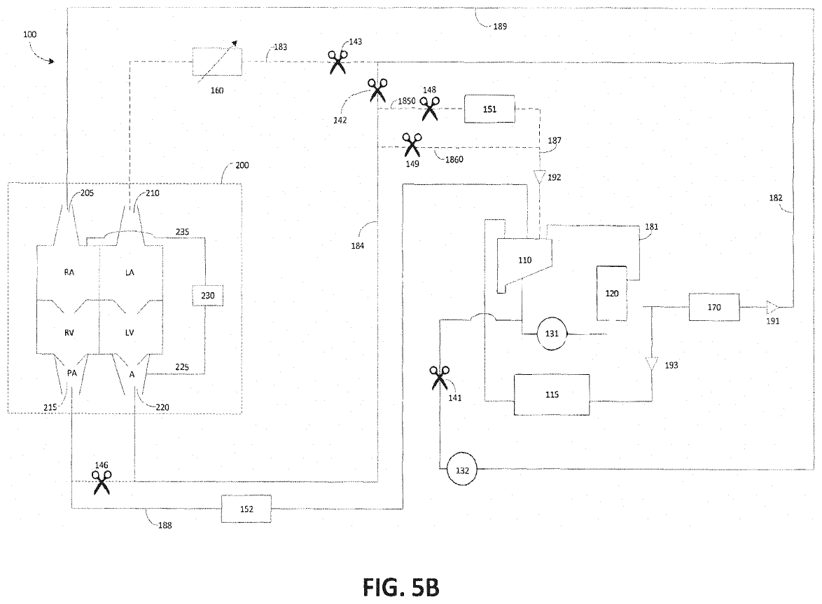

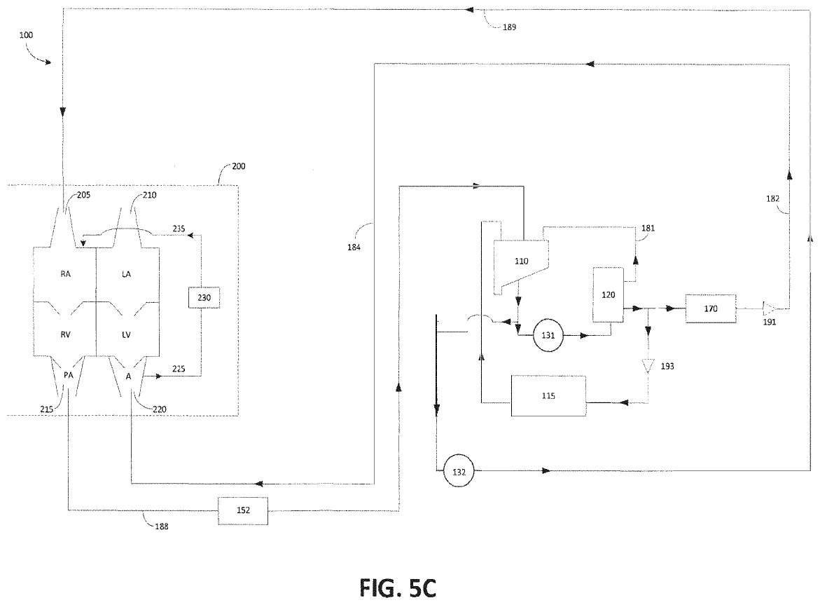

In some embodiments, system 100 is further operable to switch to right-sided working mode. FIG. 5A is a block diagram of the example system of FIG. 1A configured to operate in right-sided working mode. FIG. 5B is a block diagram of the example system of FIG. 1B configured to operate in a right-sided working mode.

As depicted in FIGS. 5A and 5B, only reservoir clamp 141 and aortic clamp 142 are open in right-sided working mode. Thus, in FIG. 5A, left atrial clamp 143, bypass clamp 144, reservoir return clamp 145 and priming clamp 146 are closed in right-sided working mode. Similarly, in FIG. 5B left atrial clamp 143, first return clamp 148, second return clamp 149 and priming clamp 146 are closed in right-sided working mode. Therefore, perfusate is drawn from reservoir 110 into both the first pump 131 and second pump 132. Right-sided working mode may operate in a similar manner to Langendorff mode, but with the second pump 132 also in operation, relative to Langendorff mode described above (in which reservoir clamp 141 is closed and second pump 132 is not active). FIG. 5C is a simplified block diagram of the example systems of FIGS. 5A and 5B in operation in which lines which do not carry fluids are not shown.

Second pump 132 is operable to pump perfusate via right-side line 189 to a connection 205 of heart 200. In some embodiments, connection 205 corresponds to the right atrium of heart 200. In some embodiments, second pump 132 is a centrifugal pump. In some embodiments, second pump 132 operates with a rotational speed of approximately 500 rpm. In some embodiments, the second pump 132 loads the right atrium with fluid at a pressure between approximately 5 to 10 mmHg. It will be appreciated that the rotational speed of second pump 132 can be adjusted so as to achieve a desired operating condition. The perfusate is pumped out of the right ventricle to pulmonary return line 188. The fluids in pulmonary return line 188 then pass through afterload 152, and then to reservoir 110.

First pump 131 is operable to pump perfusate through oxygenator 120, filter 170, and one-way valve 191 to left-side line 182. Since left atrial clamp 143, bypass clamp 144 and reservoir return clamp 145 are closed in right-sided working mode (and similarly in FIG. 5B, left atrial clamp 143, first return clamp 148 and second return clamp 149 are closed), all of the perfusate pumped by first pump 131 flows from left-side line 182 through to aortic line 184, which connects to connection 220 of heart 200. In some embodiments, connection 220 corresponds to the aorta of heart 200. The aortic valve of heart 200 is a one-way valve and shuts when subjected to the pressure of the perfusate pumped from first pump 131. The perfusate then travels into coronary arteries 225, heart tissue 230, and coronary veins 235, ultimately draining into the right atrium of heart 200. The perfusate then moves to the right ventricle, where the perfusate is pumped back to reservoir 110 via pulmonary return line 188 and afterload 152.

Right-sided working mode may facilitate the collection of data relating to the functioning of the right side of a candidate heart 200. Such data relating to the right side of heart 200 may provide important insights from a clinical perspective.

In some embodiments, system 100 further comprises a sampling line branching from the output of oxygenator 120 in any of Langendorff mode, pump-supported working mode, passive working mode, and right-sided working mode. The sampling line includes a one-way valve 193 which allows fluids to pass to sampling port 115, and then back to reservoir 110.

In each of Langendorff mode, pump-supported working mode, passive working mode, and right-sided mode, the presence of a line connecting aortic line 184 and pulmonary return line 188 is optional. In embodiments which include a line connecting aortic line 184 and pulmonary return line 188, priming clamp 146 is provided. Such a line may be useful in priming system 100, for example, to ensure that lines contain only liquids and no gases, and need not be present in any of the modes of operation described herein. In embodiments which include the line, priming clamp 146 is kept in the closed position for each of Langendorff mode, pump-supported working mode, passive working mode, and right-sided working mode.

Some embodiments of system 100 are operable to switch between any of Langendorff mode, pump-supported working mode, passive working mode, and right-sided mode. For example, switching from Langendorff mode to pump-supported working mode may be accomplished by first setting variable resistor 160 to provide elevated resistance. In some embodiments, variable resistor 160 is set to block all fluid flow. After tightening variable resistor 160, left atrial clamp 143 is opened, thereby allowing passage of some perfusate from left-side line 182 to left atrial line 183. The first pump 131 may then be adjusted so as to provide approximately 30 mmHg of pressure to the aorta (rather than the 50 mmHg described above in relation to an example embodiment). The variable resistor 160 can then be gradually loosened to allow perfusate to travel to the left atrium. The variable resistor 160 is adjusted such that perfusate is pumped into the left atrium at a pressure between approximately 5 to 10 mmHg. The left side of heart 200 would then be operating in working mode. It should be appreciated that the pressure values and rotational speed values given this example are merely examples and the system can be adjusted to use different values.

Optionally, reservoir clamp 141 can be switched from a closed position to an open position, such that a portion of the perfusate flows to second pump 132. Second pump 132 will then begin pumping perfusate to the right atrium of heart 200. The speed of second pump 132 can then be gradually increased until a desirable pressure level is reached (for example, between 5 to 10 mmHg in the right atrium). The system 100 would then be operating in full (also referred to herein as biventricular) pump-supported working mode, with both sides of heart 200 in operation.

In some embodiments, it may be desirable to adjust the pressure in various portions of the heart. For example, the right side of heart 200 can be loaded fully to the desired pressure, and the pressure at the left side of the heart can be kept low (for example, at 2 mmHg rather than the 5 to 10 mmHg described in connection with an example embodiment). Adjusting the pressures on different sides of the heart may facilitate functional evaluation and support of particular areas of the heart which may not otherwise be possible or convenient using conventional perfusion systems.

It will be appreciated that the system 100 may provide flexibility in testing various portions of the heart. For example, when reservoir clamp 141 is closed, no perfusate will flow to the right side of the heart (aside from incidental drainage from the coronary veins 235). Similarly, in some embodiments, first pump 131 pumps perfusate exclusively to the left side of heart 200 (through one or more of left atrial line 183 and aortic line 184), and second pump 132 pumps fluids exclusively to the right side of heart 200.

As a further example, the system 100 shown in FIG. 1B can be transitioned from pump-supported working mode to passive working mode. Regardless of whether reservoir clamp 141 and second pump 132 are activated, in some embodiments, system 100 can be transitioned from pump-supported working mode to passive working mode by first opening first return clamp 148, closing second return clamp 149 and closing aortic line clamp 142. Closing aortic line clamp 142 causes all of the perfusate pumped by first pump 131 to be pumped through variable resistor 160 to the left atrium via left atrial line 183. Thus, none of the perfusate flows down aortic line 184 to apply pressure to the aorta. However, with first return clamp 148 in an open state, afterload 151 stores energy as fluids pass through first return line 1850 during systole, and then afterload 151 releases stored energy and applies a reverse pressure to aortic line 184 during diastole to ensure that at least some backflow travels through the coronary arteries 225, heart tissue 230, and coronary veins 235.

As a further example, system 100 can be transitioned from Langendorff mode to passive working mode. Relative to the system shown in FIG. 1B, this transition can be accomplished by increasing the resistance of variable resistor 160 to a relatively high resistance and decreasing the pumping force of first pump 131. Left atrial clamp 143 can be opened and aortic line clamp 142 can be closed, which allows fluid to flow to variable resistor 160 and stops fluid from flowing down aortic line 184. First return clamp 148 is also opened, so as to allow perfusate to flow to first return line 1850 and afterload 151. The first pump 131 and variable resistor 160 can then be adjusted so as to achieve the desired pressure at the left atrium of heart 200.

As a further example, system 100 can be transitioned from passive working mode to Langendorff mode. Such a transition may be desirable if, for example, the heart 200 starts to fibrillate. Switching back to Langendorff mode may allow the heart 200 time to recover, and then return to working mode. Relative to the system shown in FIG. 1B, this transition can be effected by, for example, closing first return clamp 148 and left atrial clamp 143, and opening aortic line clamp 142. The variable resistor 160 may be tightened prior to closing left atrial clamp 143.

As a further example, system 100 can be transitioned from Langendorff mode to right-side working mode. This transition can be accomplished by opening reservoir clamp 141 and then gradually increasing the speed of second pump 132 until the desired pressure at the right atrium is achieved.

In some embodiments, system 100 can be transitioned from any one of Langendorff mode, pump-supported working mode, passive working mode, and right-sided working mode to any one of Langendorff mode, pump-supported working mode, passive working mode, and right-sided working mode.

In some embodiments, one or more of the systolic and diastolic pressures may be controlled by system 100. For example, in pump-supported working mode, the variable resistor 160 and first pump 131 can be set to tailor a particular pressure for fluid flowing into the left atrium. Second pump 132 can be adjusted to control the pressure for fluid flowing into the right atrium. Thus, the systolic pressure for heart 200 can be controlled by adjusting the variable resistor 160. Moreover, the diastolic pressure in system 100 can be controlled in the various modes of operation using one or more of the first pump 131 and afterload 151. For example, decreasing the speed of first pump 131 would in turn decrease the pressure at the aorta in Langendorff mode, passive working mode, and right-sided working mode. As another example, selecting or modifying the afterload 151 in passive working mode allows the backpressure exerted by afterload 151 to be adjusted. For example, in the case of a spring-loaded piston being used as afterload 151, a spring with a different spring constant k (or a different spring-loaded piston altogether) could be chosen so as to tailor the amount of backpressure applied during diastole.

In some embodiments, the adjusting of systolic and diastolic pressures may provide additional insight into the functioning of a candidate heart. For example, if a heart transplant candidate recipient suffers from hypertension (i.e. above-average blood pressure), a candidate heart 200 could be tested under elevated systolic and/or diastolic pressures to assess the likelihood that the heart 200 could perform suitably under elevated pressures.

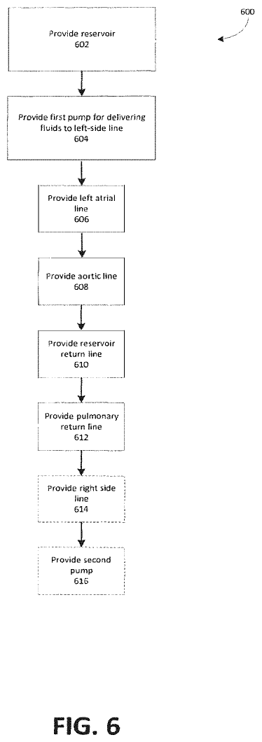

FIG. 6 is a flow chart for an example method of performing a perfusion on a heart, according to some embodiments.

The method 600 begins at 602, where a reservoir 110 is provided which contains fluid for delivery to heart 200. At 604, a first pump 131 is provided which is configured to deliver a portion of the fluid in the reservoir 110 to a left-side line 182. In some embodiments, the first pump 131 is connected to the left-side line 182 via one or more of an oxygenator 120, a filter 170, and a one-way valve 191.

At 606, a left atrial line 183 is provided. The left atrial line 183 may be connected to the left-side line 182 via a left atrial line clamp 143. The left atrial line 183 may be further connected to the left atrium of heart 200. At 608, an aortic line 184 is provided. The aortic line may be connected to the left-side line 182 via an aortic line clamp 142. The aortic line 184 may be further connected to the aorta of heart 200.

At 610, a reservoir return line 186 is provided. In some embodiments, a bypass line 185 may be provided which is connected in parallel with the reservoir return line 186. In some embodiments, bypass line 185 includes an afterload 151. The reservoir return line 186 may be connected at a proximal end to the aortic line 184 via reservoir return clamp 145. The reservoir return line 186 may be further connected at a distal end to reservoir 110, possibly via one-way valve 192. As used herein, a connection or part is described as being proximal when that connection or part is closer to heart 200 relative to a second connection or part, which is referred to as being distal. For example, the distal end of reservoir return line 186 is further away from heart 200 than the proximal end of reservoir return line 186. Optionally, a separate first return line 1850 and second return line 1860 are provided, which are both connected at respective proximal ends to aortic line 184 (as depicted in FIG. 1B). In embodiments featuring lines 1850 and 1860, lines 1850 and 1860 join to form reservoir return line 187.

At 612, a pulmonary return line 188 is provided. The pulmonary return line 188 may be connected at a distal end to reservoir 110. The pulmonary return line 188 may be further connected at a proximal end to the pulmonary artery of heart 200.

Optionally, in some embodiments, at 614, a right side line 189 is provided. The right side line 189 may be connected to the right atrium of heart 200. At 616, a second pump 132 is provided. The second pump 132 may be connected to reservoir 132. The second pump 132 may also be connected to right side line 189. The second pump 132 may be configured to pump fluid from reservoir 110 to the right atrium of heart 200.

The scope of the present application is not intended to be limited to the particular embodiments of the processes, machines, manufactures, compositions of matter, means, methods and steps described in the specification. As one of ordinary skill in the art will readily appreciate from the disclosure of the present invention, processes, machines, manufactures, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufactures, compositions of matter, means, methods, or steps.

As can be understood, the detailed embodiments described above and illustrated are intended to be examples only. Variations, alternative configurations, alternative components and modifications may be made to these example embodiments. The invention is defined by the claims.

1. (canceled)

2. A method of performing perfusion on a heart having a left atrium, a right atrium, a pulmonary artery comprising:
on a device configured for selectively performing perfusion in at least a Langendorff mode and a right-sided working mode, comprising:
a reservoir containing fluid;
a first pump configured to deliver a first portion of the fluid to a left-side line;
a left atrial line connected to the left-side line, wherein the left atrial line is configured to connect to the left atrium and the left atrial line is configured to be selectively opened and closed;
an aortic line connected to the left-side line, wherein the aortic line configured to connect to the aorta of the heart and the aortic line is configured to be selectively opened and closed;
a reservoir return line connected at a distal end to the reservoir, wherein the reservoir return line further connected at a proximal end to the aortic line via a reservoir return clamp and the reservoir return line is configured to be selectively opened and closed; and
a pulmonary return line connected at a distal end to the reservoir, the pulmonary return line configured to connect at a proximal end to the pulmonary artery;
performing profusion on the heart in the right-side working mode of the device in which the aortic line is open, the left atrial line is closed, and the reservoir return line is closed.

3. The method of claim 2, wherein the device further comprises:
a second pump connected to the reservoir, the second pump configured to pump a second portion of the fluid to a right-side line,
wherein the right-side line is configured to connect to the right atrium.

4. The method of claim 2, wherein the left atrial line of the device comprises an adjustable resistor.

5. The method of claim 2, wherein the device further comprises a return bypass line connected in parallel with the reservoir return line, wherein the bypass line is configured to be selectively opened and closed.

6. The method of claim 5, wherein the return bypass line includes a first afterload configured to store and release energy.

7. The method of claim 6, wherein the pulmonary return line comprises a second afterload configured to store and release energy.

8. The method of claim 2, wherein the left-side line of the device comprises a first valve configured to prevent the flow of gas bubbles.

9. The method of claim 8, wherein the reservoir return line of the device includes a second valve configured to prevent the flow of air from the reservoir to the aortic line.

10. The method of claim 9, wherein the device further comprises:
a sampling port connected to the left-side line via a third valve, the sampling port configured to facilitate extraction of samples of the fluid.

11. The method of claim 3, wherein at least one of the first pump and the second pump of the device is a centrifugal pump.

12. The method of claim 3, wherein the second pump of the device configured to pump the second portion of the fluid to the right atrium with a pressure of 5 to 10 mmHg.

13. The method of claim 2, further comprising performing perfusion in a mode in which the aortic line is open, the left atrial line is open, and the reservoir return line is open.

14. The method of claim 3, further comprising performing perfusion in a mode in which the aortic line is open, the left atrial line is open, and the reservoir return line is open.

15. The method of claim 3, wherein the device further comprises a return bypass line connected in parallel with the reservoir return line, wherein the return bypass line is configured to be selectively opened and closed, and the method further comprises performing perfusion in a mode in which the aortic line is closed, the left atrial line is open, the reservoir return line is closed, and the bypass is open.

16. The method of claim 3, further comprising preforming perfusion in a mode in which the aortic line is open, the left atrial line is closed, and the reservoir return line is closed.

17. The method of claim 5, further comprising performing perfusion in a mode in which the aortic line is closed, the left atrial line open, the reservoir return clamp is closed, and the bypass line is open.

18. The method of claim 2, further comprising performing perfusion in a mode in which the aortic line is open, the left atrial line is closed, and the reservoir return line is closed.

19. The method of claim 2, further comprising selectively performing perfusion in a pump-supported working mode.

20. The method of claim 2, further comprising selectively performing perfusion in a passive working mode.
